(19) United States
(12) Patent Application Publication
(10) Pub. No.: US 2023/0039595 A1
(43) Pub. Date: Feb. 9, 2023

(54) AIDED ANTENNA CALIBRATION FOR SHARED RADIO SYSTEMS

(71) Applicant: TELEFONAKTIEBOLAGET LM ERICSSON (PUBL), Stockholm (SE)

(72) Inventors: Shaohua LI, Kanata (CA); Jianguo Long, Kanata (CA)

(21) Appl. No.: 17/784,227

(22) PCT Filed: Dec. 11, 2020
(86) PCT No.: PCT/IB2020/061854

§ 371 Date: Jun. 10, 2022

Related U.S. Application Data
(60) Provisional application No. 62/947,776, filed on Dec. 13, 2019.

(51) Int. Cl. H04B 17/12; H04B 7/06

(52) U.S. Cl. CPC H04B 17/12; H04B 7/0626; H04B 7/0617

(57) ABSTRACT

A method, network node and wireless device (WD) for New Radio (NR)-WD antenna calibration for Long Term Evolution (LTE)-NR radio-shared systems are disclosed. According to one aspect, a method in a network node configured to communicate with first wireless devices according to a first radio access technology and to communicate with second wireless devices according to a second radio access technology is provided. The method includes determining a delay and phase error at a first processing block based at least in part on feedback from at least one of the first wireless devices. The method also includes compensating a first transmitted signal based at least in part on the determined delay and phase error. The method further includes compensating at a second processing block a second transmitted signal based at least in part on the determined delay and phase error received from the first processing block.

### TECHNICAL FIELD

The present disclosure relates to wireless communication and in particular, to New Radio (NR)-Wireless Device (WD) antenna calibration for shared radio systems such as Long Term Evolution (LTE)-NR radio-shared systems.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

Antenna Calibration

FIG. 1 depicts 4 correlated downlink transmit antennas. This configuration is one of the most commonly used 4-antenna configurations used in an LTE base station (eNB) and will likely also be used in NR low band systems. Four antennas are cross-polarized, i.e., the antennas are either placed with a slant angle 45° (polarization A) or −45° (polarization B). Two cross-polarized antenna pairs are closely spaced with 0.5 to 1λ separation. The advantage of such a configuration is that it provides excellent beamforming gain as the co-polarized antennas (antenna pair 0 and 1 or antenna pair 2 and 3) are correlated; and at the same time, it also allows reasonable multiplexing gain of up to 4 layers thanks to a combination of polarization diversity and sufficient spatial diversity.

Beamforming with correlated antennas requires that the phase difference between individual antenna elements is small. Any antenna error that affects this phase difference could prevent such an antenna system from realizing full beamforming potential. Ideally, to achieve beamforming gain, the antennas showed in FIG. 1 should be calibrated. However, due to cost, most of the 4 transmit antennas currently used in an LTE eNB are uncalibrated. When the wireless industry evolves into 5G, those radio antenna systems will be reused. When antennas are uncalibrated, the signal over each antenna will have different a phase φₖ, k=0,1,2,3.

For each pair of correlated co-polarized antennas in FIG. 1, i.e., antenna pair 0 and 1 for polarization A or antenna pair 2 and 3 for polarization B, the main lobe of the radiation pattern or beam during transmission points in the direction where the phases of antenna signals add constructively. Hence, the beam direction depends on the phase difference between the two co-polarized antennas. When the phase difference between two correlated antennas change, the beam direction will change as illustrated by FIG. 2.

The phase difference between antennas in each co-polarized antenna pair can be expressed approximately as:

Ø_{A}=φ₁−φ₀

and

Ø_{B}=φ₃−φ₂

If the antennas are calibrated, i.e., φₖ=0 for all k=0,1,2,3, then Ø_{A}=Ø_{B}=0 and the beams from two polarizations are aligned and point to bore sight, as illustrated by dashed line in FIG. 2.

If the antennas are not calibrated, i.e., φₖ≠0 for all k=0,1,2,3, but the phase differences of two polarizations are the same, i.e., Ø_{A}=Ø_{B}≠0, the beams from two polarizations are still aligned while beam direction will be deviated from bore sight. For example, when Ø_{A}=Ø_{B}≠135°, the beams of two polarizations can be illustrated by solid line in FIG. 2.

However, when the phase difference from two beams are not equal, i.e., Ø_{A}≠Ø_{B}, two beams will point to different directions. The example showed in FIG. 1 can be considered such as a case when Ø_{A}=0° and Ø_{A}=135°. This misalignment will lead to great performance degradation. The phase of a signal on antenna k, φ/(k,) for subcarrier frequency f, can be modeled as

φₖ=φₖ₀+2πfΔtₖ.

There are two components in φₖ: one is a fixed frequency independent phase φₖ₀, another is a frequency dependent phase caused by timing delay Δtₖ. Some have proposed a software based antenna calibration and estimation method to estimate the antenna timing delay and phase error.

LTE-NR Radio-Shared System

When 5G is rolled out, there will be coexistence with 4G for a long time. Currently, there are at least two kinds of products in which LTE and NR share the same radio resources (remote radio unit (RRU) and/or antennas). One kind of product is dynamic spectrum sharing and another kind of product is antenna splitting. Some details for dynamic spectrum sharing are known. For the antenna splitting system, the NR may use a first half of a group of radios and LTE may use the other half of the group of radios. For both products, the RRU and antenna may be shared between LTE and NR.

Dynamic Spectrum Sharing

When 5G is rolled out, operators who have deployed 4G in some portions of the available spectrum face a dilemma: should they continue to use 4G in the legacy spectrum or use 5G to replace 4G to fully reap the 5G benefit. Considering the legacy WD existence, one feasible way is to use dynamic spectrum sharing, wherein the NR and LTE radios are operated in the same spectrum and the spectrum are dynamically shared between NR and LTE. Dynamic spectrum sharing can provide service for legacy WDs as well as fully utilize new 5G features. Dynamic spectrum sharing provides a smooth re-farming solution for operators.

FIG. 3 illustrates dynamic spectrum sharing. In the dynamic spectrum sharing system, there are two kinds of WDs, one is a legacy LTE WD and one is an NR WD. The LTE WD supports LTE protocol and the NR WD supports NR protocol. From the perspective of the base station, the RRU (remote radio unit) and antenna are shared between gNB and eNB. The base station baseband includes two parts, one is gNB baseband processing blocks (gNB BB) and one is eNB baseband processing blocks (eNB BB). In the same spectrum, both legacy LTE WDs and NR WDs are served. Depending on the proportion of legacy LTE WDs, the spectrum is dynamically shared between NR and LTE.

There currently exist certain challenges. As pointed out above, antenna calibration influences LTE and NR performance. For existing 4 transmitter (TX) systems with uncalibrated antennas, one cost efficient solution is to use software-based antenna calibration. In order to improve LTE and NR performance, the straightforward method for antenna calibration is to calibrate LTE and NR separately. However, this method has several problems. First of all, it is quite challenging to perform software based antenna calibration in LTE systems. In FIG. 4, the basic software-based antenna calibration algorithm is shown. In software based antenna calibration, the base station (BS) sweeps different beams in different reference signal transmission instances (as shown in step 100). The WD estimates a precoder matrix indicator (PMI) based on beamformed RS reference signals (as shown is step 101) and feedback these PMIs to BS, and BS estimates radio delay and phase error based on the PMI feedback (as shown in step 102). As a first challenge, in step 100, in LTE, for most of the multiple input multiple output (MIMO) transmission modes, the reference signal is a cell-specific reference signal (CRS). The CRS in LTE is not only used for channel state information (CSI) feedback, it is also used for physical downlink shared channel (PDSCH) demodulation, physical downlink control channel (PDCCH) demodulation, and system information decoding. It is quite disruptive to the systems when performing beam sweeping on the (CRS). As a second challenge, in step 101, in most commercial WDs, the WD will perform averaging over time for channel estimation to improve the performance. However, the channel average over two RS instances where different beamforming is applied will substantially degrade the gNB radio delay/noise estimation. Consequently, up to now, the software based antenna calibration has not been actually applied to LTE commercial systems. On the other hand, the 3GPP NR standard has significant enhancement of CSI reports and makes the implementation of software based antenna calibration much easier in NR systems.

First, dedicated CSI-RS resources and CSI reporting can be configured for antenna calibration to avoid disruption to the normal system operations; second, 3GPP NR standards provide the means to enable/disable the averaging of reference signals when generating CSI reports.

Second, it is not necessary to have both gNB and eNB calibration simultaneously in a LTE-NR radio-shared system. As shown in FIG. 3, the RRU and antenna are shared by the gNB and the eNB. In principle, the radio delay and phase error are introduced from the RRU and antenna. Thus, the radio delay and phase error are the same for both the gNB and the eNB. As a result, it is redundant to estimate delay and phase error in both gNB and eNB.

### SUMMARY

Some embodiments advantageously provide a method and system for NR-WD antenna calibration for LTE-NR radio-shared systems. Various embodiments address one or more of the issues disclosed above and herein.

In some embodiments, an NR WD is used to aid a gNB for radio delay and phase error estimation and further aid an eNB to perform delay and phase compensation, which improves both NR and LTE system performance

In some embodiments, an NR WD performs radio delay and phase error measurements and compensation on an NR gNB signal; the gNB then sends this information to LTE eNB to help the eNB compensate its transmission signal when the gNB and the eNB share the same radio unit (i.e., RRU and antenna).

Some methods proposed herein may improve LTE system performance

According to one aspect, a network node configured to transmit signals to first wireless devices according to a first radio access technology and to transmit signals to second wireless devices according to a second radio access technology is provided. The network node includes a first processing block operating according to the first radio access technology and configured to: determine a delay and phase error based at least in part on feedback from at least one of the first wireless devices; and compensate a first transmitted signal based at least in part on the determined delay and phase error. The network node further includes a second processing block operating according to the second radio access technology and configured to compensate a second transmitted signal based at least in part on the determined delay and phase error received from the first processing block.

According to this aspect, in some embodiments, the compensated first transmitted signal is transmitted to at least one of the first wireless devices. In some embodiments, the compensated second transmitted signal is transmitted to at least one of the second wireless devices. In some embodiments, the first radio access technology is New Radio, NR, and the second radio access technology is Long Term Evolution, LTE. In some embodiments, the determined delay and phase error are monitored over time and reported periodically to the second processing block. In some embodiments, both the first and second processing blocks being in communication with a same remote radio unit at the network node.

According to another aspect, a method in a network node configured to communicate with first wireless devices according to a first radio access technology and to communicate with second wireless devices according to a second radio access technology is provided. The method includes determining a delay and phase error at a first processing block based at least in part on feedback from at least one of the first wireless devices. The method also includes compensating a first transmitted signal based at least in part on the determined delay and phase error. The method further includes compensating at a second processing block a second transmitted signal based at least in part on the determined delay and phase error received from the first processing block.

According to this aspect, in some embodiments, the compensated first transmitted signal is transmitted to at least one of the first wireless devices. In some embodiments, the compensated second transmitted signal is transmitted to at least one of the second wireless devices. In some embodiments, the first radio access technology is New Radio, NR, and the second radio access technology is Long Term Evolution, LTE. In some embodiments, the determined delay and phase error are monitored over time and reported periodically to the second processing block. In some embodiments, both the first and second processing blocks being in communication with a same remote radio unit at the network node.

According to yet another aspect, a network node configured to communicate with New Radio, NR, wireless devices and to communicate with Long Term Evolution, LTE, wireless devices is provided. The network node includes an NR processing block configured to: determine a delay and phase error based at least in part on feedback from at least one of the NR wireless devices; and compensate transmitted first signals based at least in part on the determined delay and phase error. The network node further includes an LTE processing block being configured to compensate transmitted second signals based at least in part on the determined delay and phase error received from the NR processing block.

According to this aspect, in some embodiments, the compensated transmitted first signals are transmitted to at least one of the NR wireless devices. In some embodiments, the compensated transmitted second signals are transmitted to at least one of the LTE wireless devices. In some embodiments, the determined delay and phase error are monitored over time and transmitted to the LTE processing block periodically. In some embodiments, the network node is a combination of an NR base station, gNB, and an LTE base station, eNB. In some embodiments, the network node further includes a remote radio unit to transmit first signals to the NR wireless devices and to transmit second signals to the LTE wireless devices. In some embodiments, the delay and phase error are determined at a frequency that is used for transmission by the remote radio unit of both the first signals and the second signals.

According to yet another aspect, a method in a network node is configured to communicate with New Radio, NR, wireless devices and to communicate with Long Term Evolution, LTE, wireless devices. The method includes determining a delay and phase error based at least in part on feedback from at least one of the NR wireless devices. The method also includes compensating transmitted first signals based at least in part on the determined delay and phase error, and compensating transmitted second signals based at least in part on the determined delay and phase error.

According to this aspect, in some embodiments, the compensated transmitted first signals are transmitted to at least one of the NR wireless devices. In some embodiments, the compensated transmitted second signals are transmitted to at least one of the LTE wireless devices. In some embodiments, the determined delay and phase error are monitored over time and transmitted to the LTE processing block periodically. In some embodiments, the network node is a combination of an NR base station, gNB, and an LTE base station, eNB. In some embodiments, the method also includes transmitting first signals to the NR wireless devices and to transmit second signals to the LTE wireless devices. In some embodiments, the delay and phase error are determined at a frequency that is used for transmission of both the first signals and the second signals.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates 4 correlated transmit antennas

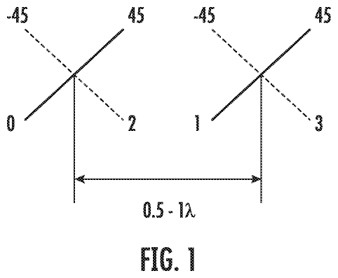

FIG. 2 shows two beams pointing in different directions with phase difference changes;

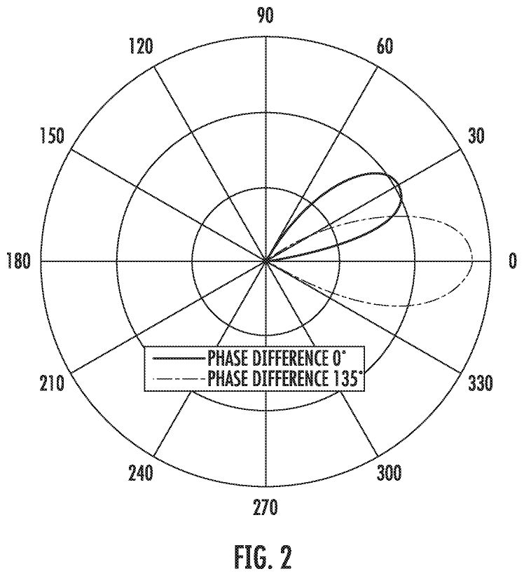

FIG. 3 shows a base station configured for dynamic spectrum sharing;

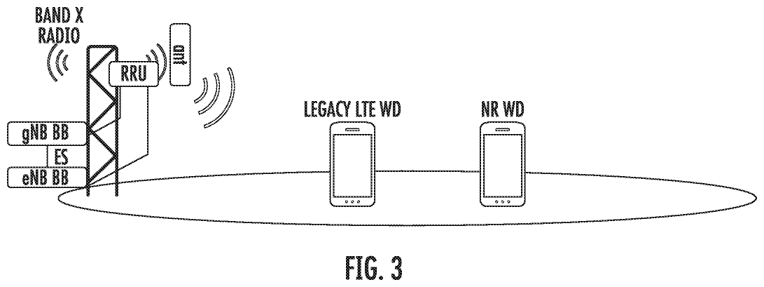

FIG. 4 illustrates an antenna calibration algorithm

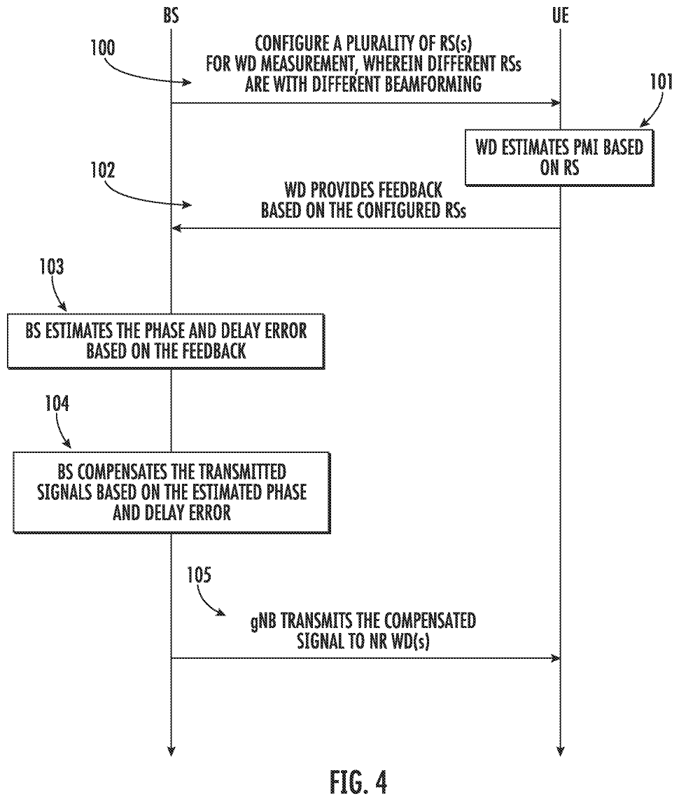

FIG. 5 is a flow diagram of example process according to principles disclosed herein;

FIG. 6 is a block diagram of a wireless network according to some embodiments disclosed herein;

FIG. 7 is a block diagram of a WD according to some embodiments disclosed herein;

FIG. 8 is block diagram of a virtualization environment according to some embodiments disclosed herein;

FIG. 9 is a block diagram of a wireless communication network connected via an intermediate network to a host computer according to some embodiments disclosed herein;

FIG. 10 is a block diagram of a host computer communicating via a base station with a WD over a partially wireless connection according to some embodiments disclosed herein;

FIG. 11 is a flowchart of an example process in the communication network of FIG. 10;

FIG. 12 is a flowchart of another example process in the communication network of FIG. 10;

FIG. 13 is a flowchart of yet another example process in the communication network of FIG. 10;

FIG. 14 is a flowchart of a further example process in the communication network of FIG. 10;

FIG. 15 is a flowchart of an example method in a NR user according to some embodiments disclosed herein;

FIG. 16 is a block diagram of an example virtualization apparatus according to some embodiments disclosed herein;

FIG. 17 is a block diagram of processing circuitry having NR and LTE processing blocks configured according to some embodiments disclosed herein;

FIG. 18 is a flowchart of an example process in a network node configured to compensate a signal according to some embodiments disclosed herein; and

FIG. 19 is a flowchart of another example process in a network node configured to compensate a signal according to some embodiments disclosed herein.

### DETAILED DESCRIPTION

Before describing in detail exemplary embodiments, it is noted that the embodiments reside primarily in combinations of apparatus components and processing steps related to NR-WD antenna calibration for LTE-NR radio-shared systems. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, NR-WD antenna calibration for LTE-NR radio-shared systems is provided. Some embodiments disclosed herein will now be described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

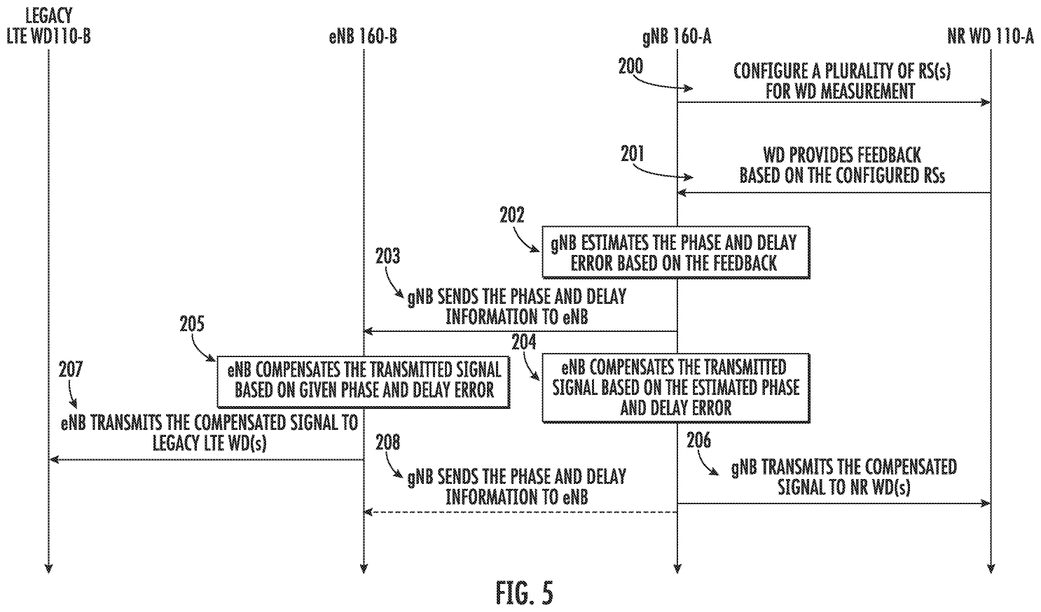

Referring again to the drawing figures, FIG. 5 is a flowchart of an example process performed by interaction between a NR WD 110-A, a gNB 160-A, an LTE legacy WD 100-B and an eNB 160-B. In step 200, the gNB 160-A configures a plurality of RSs for the NR WD 110-A WD to perform channel and/or interference measurement. A RS could be one or more of, for example, CSI-RS, demodulation reference signal (DMRS), tracking reference signal (TRS), phase tracking reference signal (PTRS), primary synchronization signal (PSS), secondary synchronization signal (SSS), or any other reference signal. For each RS, different beamforming can be applied. The NR WD 110-A may perform CSI estimation based on a configured RS. The CSI may consist of a Channel Quality Indicator (CQI), precoding matrix indicator (PMI), CSI-RS resource indicator (CRI), SS/PBCH Block Resource indicator (SSBRI), layer indicator (LI), rank indicator (RI) and/or L1-RSRP.

In step 201, the NR WD 110-A provides CSI feedback to the gNB 160-A. After the gNB 160-A obtains CSI feedback, the gNB 160-A estimates the radio phase and delay error as shown in step 202. Conventional methods may be employed for this step in some examples.

In step 203, the gNB 160-A sends the estimated radio phase and delay error to the eNB 160-B. The eNB 160-B uses the signaled radio phase and delay error to compensate the transmitted signal (as shown in Step 205) and further transmit the compensated signal to the legacy LTE WDs 110-B (as shown in Step 207). Note that WDs 110-A and WDs 110-B may be referred to hereinafter collectively as WDs 110. Further, WDs 110 may be referred to as WDs QQ110.

In step 204, the gNB 160-A also uses the estimated radio phase and delay error to compensate the gNB 160-A transmitted signal and transmits the corresponding compensated signal to NR WDs 110-A (as shown in Step 206).

In order to track the delay and phase shift over time, the gNB 160-A needs to track the delay and phase error over time and update them to the eNB 160-B as well (as shown in Step 208). The update can be periodic or optionally aperiodic.

With the arrangements disclosed herein, both gNB 160-A and eNB 160-B may achieve the maximum spectrum efficiency via delay and phase compensation. Note that gNB 160-A and eNB 160-B may be referred to hereinafter collectively as network nodes 160. Further, network nodes 160 may be referred to as network nodes QQ160.

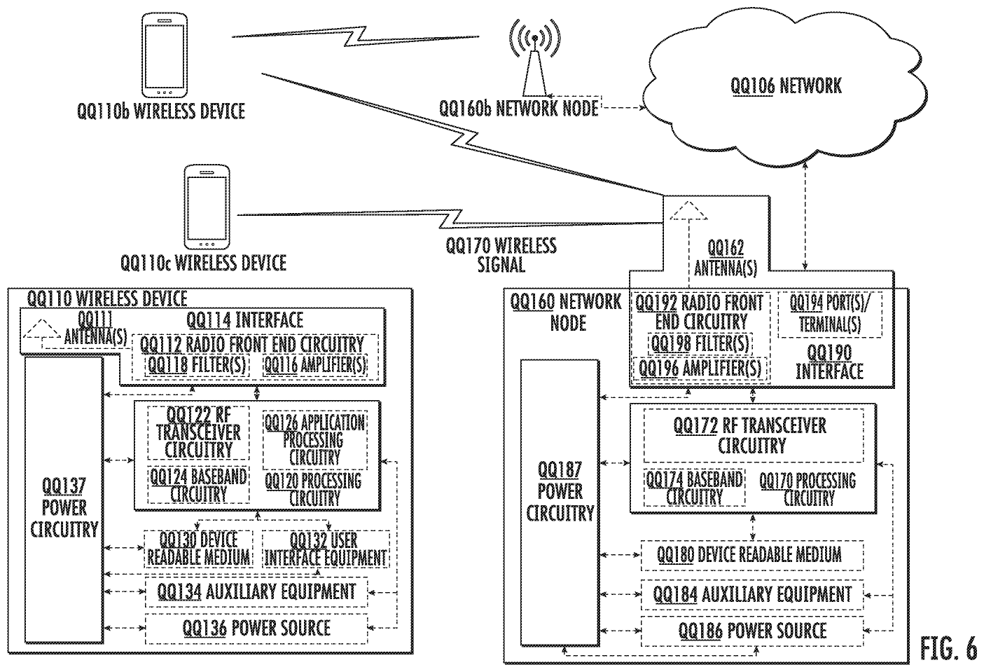

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network QQ106, network nodes QQ160 and QQ160b, and WDs QQ110, QQ110b, and QQ110c. The network nodes QQ160, QQ160b and QQ160c may be gNBs 160-A. The WDs QQ110, QQ110b and QQ110c may be NR WDs 110-A shown in FIG. 5. In practice, a wireless network may further include any additional elements suitable to support communication between WDs QQ110 or between a WD QQ110 and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices QQ110, QQ110b and QQ110c to facilitate the wireless devices' access to and/or use of the services provided by, or via, the wireless network. Note that the terms “wireless device” and “user equipment” may be used in this disclosure interchangeably.

The wireless network may include and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the Institute of Electrical and Electronics (IEEE) 802.11 standards; and/or any other appropriate wireless communication standard, such as the Worldwide Interoperability for Microwave Access (WiMax), Bluetooth, Z-Wave and/or ZigBee standards.

Network QQ106 may include one or more backhaul networks, core networks, Internet Protocol (IP) networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 include various components described in more detail below. These components work together in order to provide network node and/or wireless device functionality, such as providing wireless connections in a wireless network. In different embodiments, the wireless network may include any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node QQ160 includes processing circuitry QQ170, device readable medium QQ180, radio interface QQ190, auxiliary equipment QQ184, power source QQ186, power circuitry QQ187, and antenna QQ162. Although network node QQ160 illustrated in the example wireless network of FIG. 6 may represent a device that includes the illustrated combination of hardware components, other embodiments may include network nodes QQ160 with different combinations of components. It is to be understood that a network node includes any suitable combination of hardware and/or software needed to perform the tasks, features, functions and methods disclosed herein. Moreover, while the components of network node QQ160 are depicted as single boxes located within a larger box, or nested within multiple boxes, in practice, a network node QQ160 may include multiple different physical components that make up a single illustrated component (e.g., device readable medium QQ180 may include multiple separate hard drives as well as multiple RAM modules).

Similarly, network node QQ160 may be composed of multiple physically separate components (e.g., a NodeB component and a radio network controller (RNC) component, or a base transceiver station (BTS) component and a base station controller (BSC) component, etc.), which may each have their own respective components. In certain scenarios in which network node QQ160 includes multiple separate components (e.g., BTS and BSC components), one or more of the separate components may be shared among several network nodes QQ160. For example, a single RNC may control multiple NodeBs. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, Global System for Mobile communications (GSM), wideband code division multiple access, (WCDMA), LTE, NR, Wi-Fi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may include a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units

In certain embodiments, some or all of the functionality described herein as being provided by a network node 160, base station, eNB 160-B or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but may accrue to the benefit of network node QQ160 as a whole, and/or by end users and the wireless network generally.

Device readable medium QQ180 may include any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via radio interface QQ190. In some embodiments, processing circuitry QQ170 and device readable medium QQ180 may be considered to be integrated.

Radio interface QQ190 is used in the wired or wireless communication of signaling and/or data between network node QQ160, network QQ106, and/or WDs QQ110. As illustrated, radio interface QQ190 includes port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 includes filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may include different components and/or different combinations of components.

In certain alternative embodiments, network node QQ160 may not include separate radio front end circuitry QQ192, instead, processing circuitry QQ170 may include radio front end circuitry and may be connected to antenna QQ162 without separate radio front end circuitry QQ192. Similarly, in some embodiments, all or some of RF transceiver circuitry QQ172 may be considered a part of radio interface QQ190. In still other embodiments, radio interface QQ190 may include one or more ports or terminals QQ194, radio front end circuitry QQ192, and RF transceiver circuitry QQ172, as part of a radio unit (not shown), and radio interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may include one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, radio interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, radio interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may include, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may include a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. 6 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) or user equipment (UE) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a WD implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, Wi-Fi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD 110. Any information, data and/or signals may be received from a network node 160 and/or another WD 110. In some embodiments, radio front end circuitry and/or antenna QQ111 may be considered an interface.

As illustrated, interface QQ114 includes radio front end circuitry QQ112 and antenna QQ111. Radio front end circuitry QQ112 include one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may include radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may include different components and/or different combinations of components.

Processing circuitry QQ120 may include a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may include different components and/or different combinations of components. In certain embodiments processing circuitry QQ120 of WD QQ110 may include a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may include specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further include power circuitry QQ137 for delivering power from power source QQ136 to the various parts of WD QQ110 which need power from power source QQ136 to carry out any functionality described or indicated herein. Power circuitry QQ137 may in certain embodiments include power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

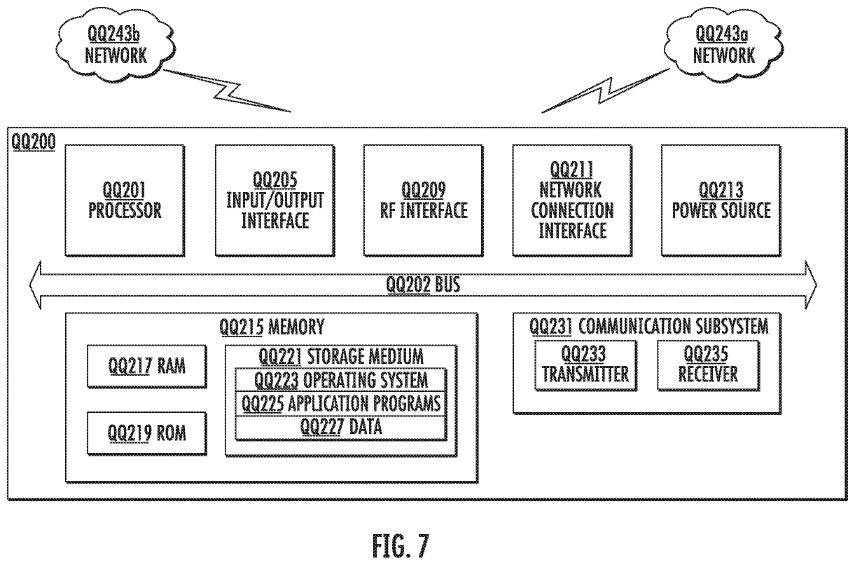

FIG. 7 illustrates one embodiment of a WD QQ200 in accordance with various aspects described herein. In particular, WD QQ200 may be a NR WD such as NR WD 110-A shown in FIG. 5. As used herein, a user equipment or WD may not necessarily have a user in the sense of a human user who owns and/or operates the relevant device. Instead, WD QQ200 may represent a device that is intended for sale to, or operation by, a human user but which may not, or which may not initially, be associated with a specific human user (e.g., a smart sprinkler controller). Alternatively, WD QQ200 may represent a device that is not intended for sale to, or operation by, an end user but which may be associated with or operated for the benefit of a user (e.g., a smart power meter). WD QQ2000 may be any WD identified by the 3rd Generation Partnership Project (3GPP), including a narrow band Internet of things (NB-IoT) WD, a machine type communication (MTC) WD, and/or an enhanced MTC (eMTC) WD. WD QQ200, as illustrated in FIG. 7, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable.

In FIG. 7, WD QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain WDs may utilize all of the components shown in FIG. 7, or only a subset of the components. The level of integration between the components may vary from one WD QQ200 to another WD QQ200. Further, certain WD QQ200s may contain multiple instances of a component, such as multiple processors, memories, transceivers, transmitters, receivers, etc.

In FIG. 7, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, field programmable gate array (FPGA), application specific integrated circuit (ASIC), etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. WD QQ200 may be configured to use an output device via input/output interface QQ205. An output device may use the same type of interface port as an input device. For example, a universal serial bus (USB) port may be used to provide input to and output from WD QQ200. The output device may be a speaker, a sound card, a video card, a display, a monitor, a printer, an actuator, an emitter, a smartcard, another output device, or any combination thereof. WD QQ200 may be configured to use an input device via input/output interface QQ205 to allow a user to capture information into WD QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may include a Wi-Fi network. Network connection interface QQ211 may be configured to include a receiver and a transmitter interface used to communicate with one or more other devices over a communication network according to one or more communication protocols, such as Ethernet, Transmission Control Protocol (TCP)/IP, synchronous optical network (SONET), asynchronous transfer mode ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by WD QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow WD QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may include a device readable medium.

In FIG. 7, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of WD QQ200.

The features, benefits and/or functions described herein may be implemented in one of the components of WD QQ200 or partitioned across multiple components of WD QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

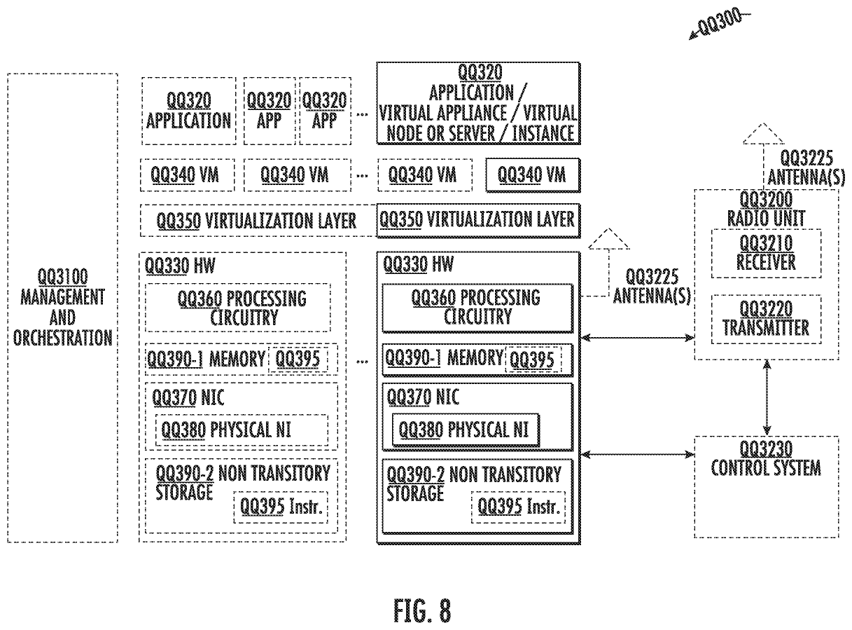

FIG. 8 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, includes general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may include memory QQ390-1 which may be non-persistent memory for temporarily storing instructions QQ395 or software executed by processing circuitry QQ360. Each hardware device may include one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, include virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. 8, hardware QQ330 may be a standalone network node with generic or specific components. Hardware QQ330 may include antenna QQ3225 and may implement some functions via virtualization. Alternatively, hardware QQ330 may be part of a larger cluster of hardware (e.g., such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. 8.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signaling can be effected with the use of control system QQ3230 which may alternatively be used for communication between the hardware nodes QQ330 and radio units QQ3200.

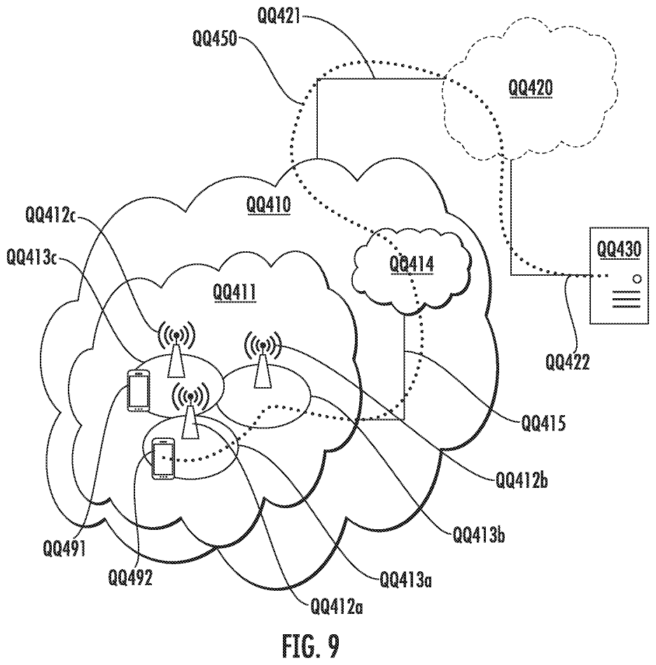

With reference to FIG. 9, in accordance with an embodiment, a communication system includes telecommunication network QQ410, such as a 3GPP-type cellular network, which includes access network QQ411, such as a radio access network, and core network QQ414. Access network QQ411 includes a plurality of network nodes QQ412a, QQ412b, QQ412c, such as network nodes including NB s, eNBs, gNBs or other types of wireless access points, each defining a corresponding coverage area QQ413a, QQ413b, QQ413c. Each network node QQ412a, QQ412b, QQ412c is connectable to core network QQ414 over a wired or wireless connection QQ415. A first WD QQ491 located in coverage area QQ413c is configured to wirelessly connect to, or be paged by, the corresponding network node QQ412c. A second WD QQ492 in coverage area QQ413a is wirelessly connectable to the corresponding network node QQ412a. While a plurality of WDs QQ491, QQ492 are illustrated in this example, the disclosed embodiments are equally applicable to a situation where a sole WD is in the coverage area or where a sole WD is connecting to the corresponding network node QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may include two or more sub-networks (not shown).

The communication system of FIG. 9 as a whole enables connectivity between the connected WDs QQ491, QQ492 and host computer QQ430. The connectivity may be described as an over-the-top (OTT) connection QQ450. Host computer QQ430 and the connected WDs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, network node QQ412 may not or need not be informed about the past routing of an incoming downlink communication with data originating from host computer QQ430 to be forwarded (e.g., handed over) to a connected WD QQ491. Similarly, network node QQ412 need not be aware of the future routing of an outgoing uplink communication originating from the WD QQ491 towards the host computer QQ430.

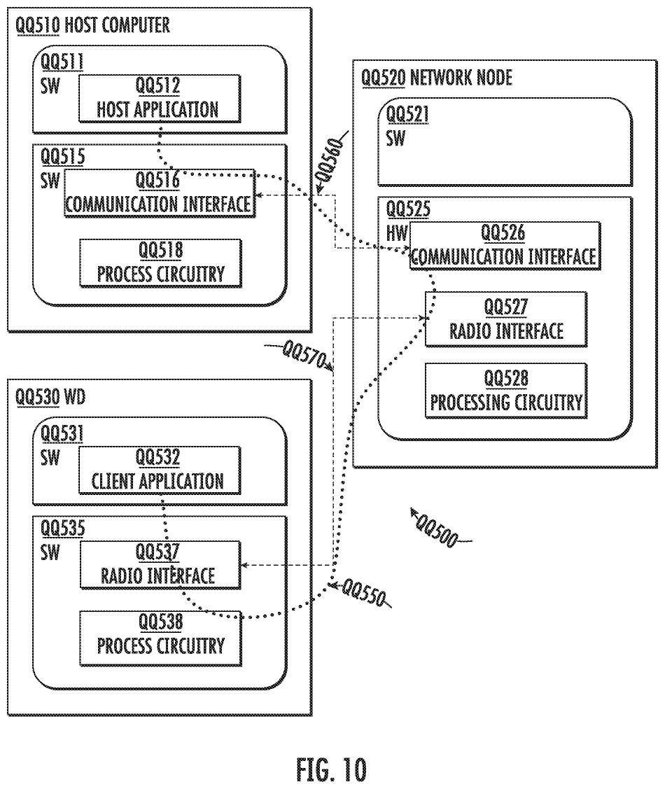

Example implementations, in accordance with an embodiment, of the WD, network node and host computer discussed in the preceding paragraphs will now be described with reference to FIG. 10. In communication system QQ500, host computer QQ510 includes hardware QQ515 including communication interface QQ516 configured to set up and maintain a wired or wireless connection with an interface of a different communication device of communication system QQ500. Host computer QQ510 further includes processing circuitry QQ518, which may have storage and/or processing capabilities. In particular, processing circuitry QQ518 may include one or more programmable processors, application-specific integrated circuits, field programmable gate arrays or combinations of these (not shown) adapted to execute instructions. Host computer QQ510 further includes software QQ511, which is stored in or accessible by host computer QQ510 and executable by processing circuitry QQ518. Software QQ511 includes host application QQ512. Host application QQ512 may be operable to provide a service to a remote user, such as WD QQ530 connecting via OTT connection QQ550 terminating at WD QQ530 and host computer QQ510. In providing the service to the remote user, host application QQ512 may provide user data which is transmitted using OTT connection QQ550.

Communication system QQ500 further includes network node QQ520 provided in a telecommunication system and comprising hardware QQ525 enabling it to communicate with host computer QQ510 and with WD QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with WD QQ530 located in a coverage area (not shown in FIG. 10) served by network node QQ520. Communication interface QQ526 may be configured to facilitate connection QQ560 to host computer QQ510. Connection QQ560 may be direct or it may pass through a core network (not shown in FIG. 10) of the telecommunication system and/or through one or more intermediate networks outside the telecommunication system. In the embodiment shown, hardware QQ525 of network node QQ520 further includes processing circuitry QQ528, which may include one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes WD QQ530 already referred to. Hardware QQ535 may include radio interface QQ537 configured to set up and maintain wireless connection QQ570 with a network node serving a coverage area in which WD QQ530 is currently located. Hardware QQ535 of WD QQ530 further includes processing circuitry QQ538, which may include one or more programmable processors, application-specific integrated circuits, field programmable gate arrays or combinations of these (not shown) adapted to execute instructions. WD QQ530 further includes software QQ531, which is stored in or accessible by WD QQ530 and executable by processing circuitry QQ538. Software QQ531 includes client application QQ532. Client application QQ532 may be operable to provide a service to a human or non-human user via WD QQ530, with the support of host computer QQ510. In host computer QQ510, an executing host application QQ512 may communicate with the executing client application QQ532 via OTT connection QQ550 terminating at WD QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, network node QQ520 and WD QQ530 illustrated in FIG. 10 may be similar or identical to host computer QQ430, one of network nodes QQ412a, QQ412b, QQ412c and one of WDs QQ491, QQ492 of FIG. 9, respectively. This is to say, the inner workings of these entities may be as shown in FIG. 10 and independently, the surrounding network topology may be that of FIG. 9.

In FIG. 10, OTT connection QQ550 has been drawn abstractly to illustrate the communication between host computer QQ510 and WD QQ530 via network node QQ520, without explicit reference to any intermediary devices and the precise routing of messages via these devices. Network infrastructure may determine the routing, which it may be configured to hide from WD QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between WD QQ530 and network node QQ520 is in accordance with the teachings of the embodiments described throughout this disclosure. One or more of the various embodiments improve the performance of OTT services provided to WD QQ530 using OTT connection QQ550, in which wireless connection QQ570 forms the last segment. More precisely, the teachings of these embodiments may improve the LTE system performance, and thereby provide benefits such as obtain greater efficiency via delay and phase compensation.

A measurement procedure may be provided for the purpose of monitoring data rate, latency and other factors on which the one or more embodiments improve. There may further be an optional network functionality for reconfiguring OTT connection QQ550 between host computer QQ510 and WD QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of WD QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect network node QQ520, and it may be unknown or imperceptible to network node QQ520. Such procedures and functionalities may be known and practiced in the art. In certain embodiments, measurements may involve proprietary WD signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

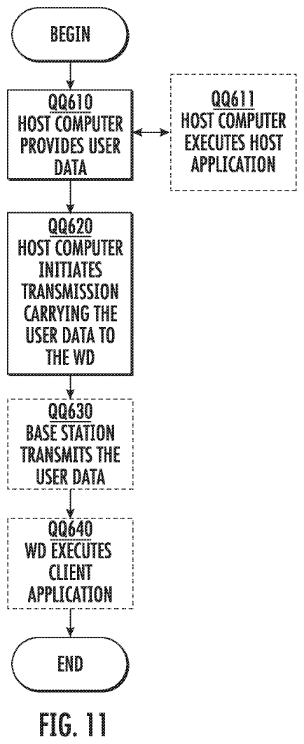

FIG. 11 is a flowchart illustrating a method implemented in a communication system, in accordance with one embodiment. The communication system includes a host computer, a network node 160 and a WD, such as LTE legacy WD 110-B or NR WD 110-A (hereinafter referred to collectively as WDs 110), which may be those described with reference to FIGS. 9 and 10. For simplicity of the present disclosure, only drawing references to FIG. 11 will be included in this section. In step QQ610, the host computer provides user data. In substep QQ611 (which may be optional) of step QQ610, the host computer provides the user data by executing a host application. In step QQ620, the host computer initiates a transmission carrying the user data to the WD 110. In step QQ630 (which may be optional), the network node 160 transmits to the WD 110 the user data which was carried in the transmission that the host computer initiated, in accordance with the teachings of the embodiments described throughout this disclosure. In step QQ640 (which may also be optional), the WD 110 executes a client application associated with the host application executed by the host computer.

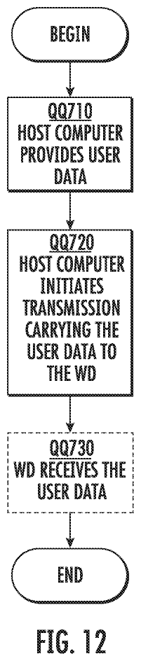

FIG. 12 is a flowchart illustrating a method implemented in a communication system, in accordance with one embodiment. The communication system includes a host computer, a network node 160 and a WD 110 which may be those described with reference to FIGS. 9 and 10. For simplicity of the present disclosure, only drawing references to FIG. 12 will be included in this section. In step QQ710 of the method, the host computer provides user data. In an optional substep (not shown) the host computer provides the user data by executing a host application. In step QQ720, the host computer initiates a transmission carrying the user data to the WD 110. The transmission may pass via the network node 160, in accordance with the teachings of the embodiments described throughout this disclosure. In step QQ730 (which may be optional), the WD 110 receives the user data carried in the transmission.

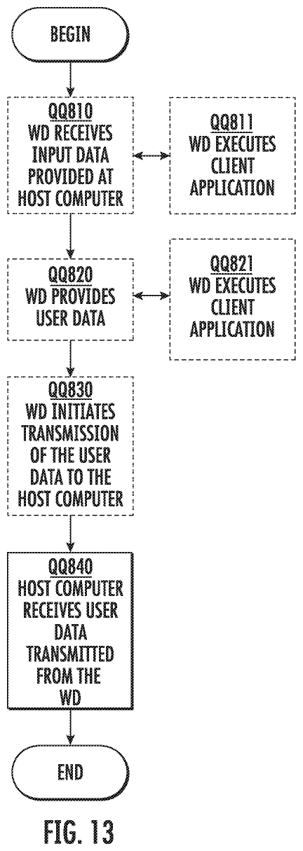

FIG. 13 is a flowchart illustrating a method implemented in a communication system, in accordance with one embodiment. The communication system includes a host computer, a network node 160 and a WD 110 which may be those described with reference to FIGS. 9 and 10. For simplicity of the present disclosure, only drawing references to FIG. 13 will be included in this section. In step QQ810 (which may be optional), the WD 110 receives input data provided by the host computer. Additionally or alternatively, in step QQ820, the WD 110 provides user data. In substep QQ821 (which may be optional) of step QQ820, the WD 110 provides the user data by executing a client application. In sub step QQ811 (which may be optional) of step QQ810, the WD 110 executes a client application which provides the user data in reaction to the received input data provided by the host computer. In providing the user data, the executed client application may further consider user input received from the user. Regardless of the specific manner in which the user data was provided, the WD 110 initiates, in substep QQ830 (which may be optional), transmission of the user data to the host computer. In step QQ840 of the method, the host computer receives the user data transmitted from the WD 110, in accordance with the teachings of the embodiments described throughout this disclosure.

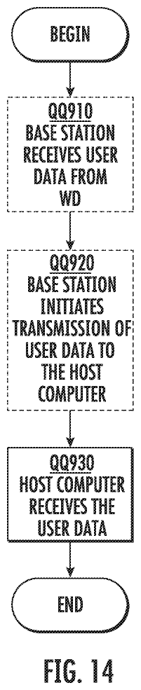

FIG. 14 is a flowchart illustrating a method implemented in a communication system, in accordance with one embodiment. The communication system includes a host computer, a network node 160 and a WD 110 which may be those described with reference to FIGS. 9 and 10. For simplicity of the present disclosure, only drawing references to FIG. 14 will be included in this section. In step QQ910 (which may be optional), in accordance with the teachings of the embodiments described throughout this disclosure, the network node 160 receives user data from the WD 110. In step QQ920 (which may be optional), the network node 160 initiates transmission of the received user data to the host computer. In step QQ930 (which may be optional), the host computer receives the user data carried in the transmission initiated by the network node 160.

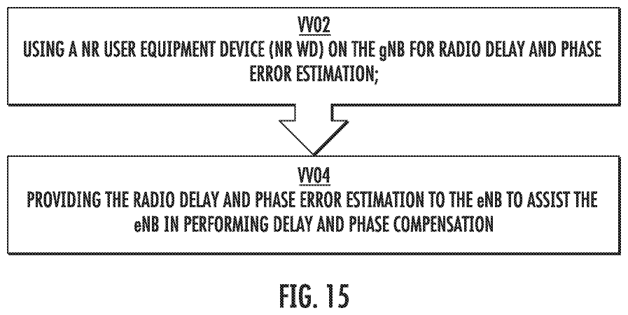

FIG. 15 depicts a method in accordance with particular embodiments. This embodiment is directed toward a method to calibrate an antenna is a wireless network where a NR network node (gNB 160-A) and an LTE network node (eNB 160-B) share a radio unit. The method begins at step VV02 with the use of a NR user equipment device (NR WD 110-A) on the gNB 160-A for radio delay and phase error estimation, or measurement. As step VV04, the radio delay and phase error estimation are provided to the eNB 160-B to assist the eNB 160-B in performing delay and phase compensation.

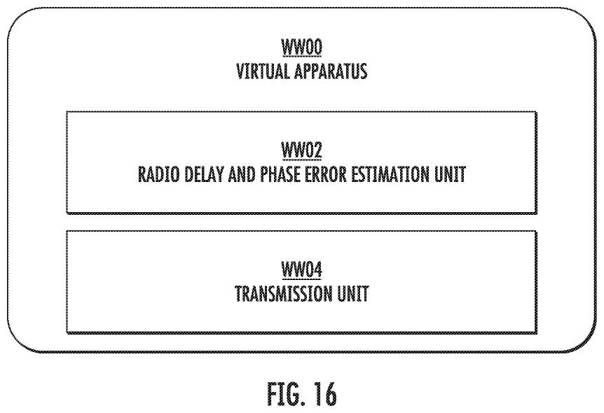

FIG. 16 illustrates a schematic block diagram of an apparatus WW00 in a wireless network (for example, the wireless network shown in FIG. 6). The apparatus may be implemented in a wireless device 110 or network node 160 (e.g., wireless device QQ110 or network node QQ160 shown in FIG. 6). Apparatus WW00 is operable to carry out the example method described with reference to FIG. 15 and possibly any other processes or methods disclosed herein. It is also to be understood that the method of FIG. 15 is not necessarily carried out solely by apparatus WW00. At least some operations of the method can be performed by one or more other entities.

Virtual Apparatus WW00 may include processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause Radio Delay and Phase Error Estimation unit WW02, Transmission unit WW04, and any other suitable units of apparatus WW00 to perform corresponding functions according one or more embodiments of the present disclosure.

As illustrated in FIG. 16, apparatus WW00 includes a Radio Delay and Phase Error Estimation unit WW02 and a Transmission unit WW04, where Radio Delay and Phase Error Estimation] unit WW02 is configured to use a NR user equipment device (NR WD) on the gNB 160-A for radio delay and phase error estimation and Transmission unit WW04 is configured to provide the radio delay and phase error estimation to the eNB 160-B to assist the eNB 160-B in performing delay and phase compensation.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

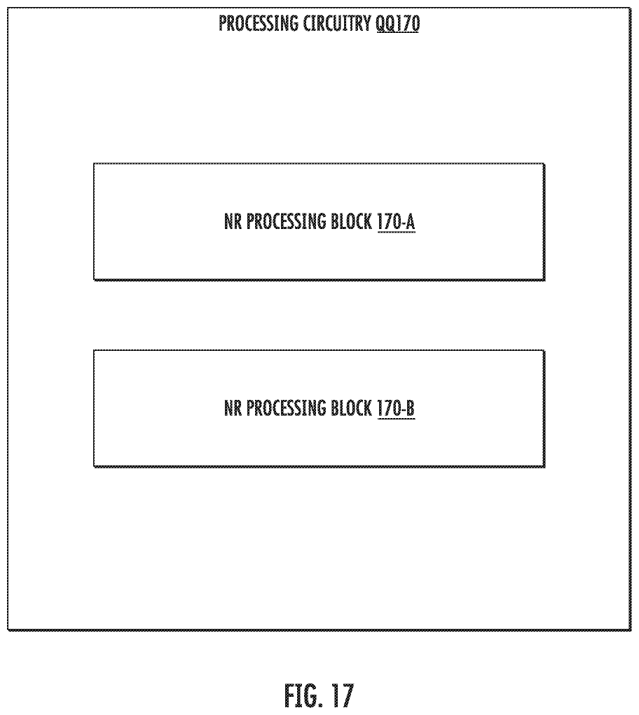

FIG. 17 is a block diagram of processing circuitry QQ170 in a network node 160, for example, having NR and LTE processing blocks 170-A and 170-B, respectively. The NR processing block 170-A operates according to NR technology and is configured to determine a delay and phase error based at least in part on feedback from at least one of the first wireless devices 110-A and to compensate a first transmitted signal based at least in part on the determined delay and phase error. The LTE processing block 170-B operates according to LTE technology and is configured to compensate a second transmitted signal based at least in part on the determined delay and phase error received from the NR processing block 170-A.

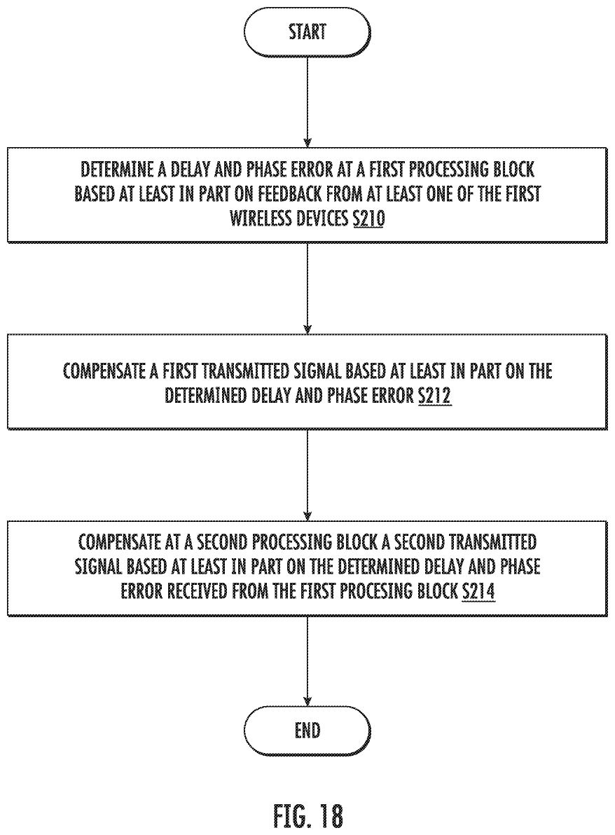

FIG. 18 is a flowchart of an example process in a network node 160 configured to communicate with first wireless devices 110-A according to a first radio access technology and to communicate with second wireless devices 110-B according to a second radio access technology. The process includes determining, via, for example, processing circuitry QQ170, a delay and phase error at a first processing block based at least in part on feedback from at least one of the first wireless devices 110-A (Block S210). The process also includes compensating, via the processing circuitry QQ170, for example, a first transmitted signal based at least in part on the determined delay and phase error (Block S212). The process further includes compensating, via the processing circuitry QQ170, for example, at a second processing block a second transmitted signal based at least in part on the determined delay and phase error received from the first processing block (Block S214).

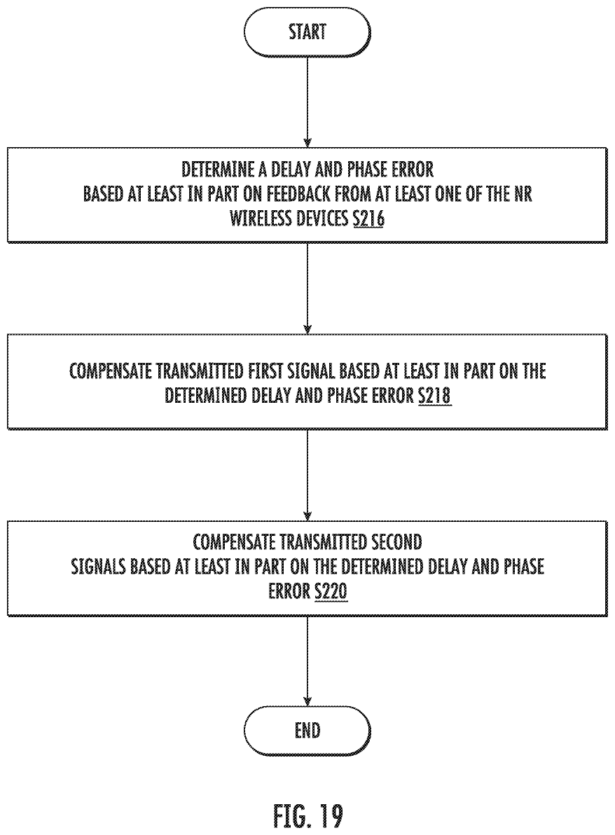

FIG. 19 is a flowchart of an example process in a network node 160 configured to communicate with NR wireless devices 110-A according to the NR radio access technology and to communicate with LTE wireless devices 110-B according to the LTE radio access technology. The process includes determining, via, for example, processing circuitry QQ170, a delay and phase error based at least in part on feedback from at least one of the NR wireless devices 110-A (Block S116). The process also includes compensating transmitted first signals based at least in part on the determined delay and phase error (Block S118). The process further includes compensating transmitted second signals based at least in part on the determined delay and phase error (Block S120).

According to one aspect, a network node 160 is configured to transmit signals to first wireless devices 110-A according to a first radio access technology and to transmit signals to second wireless devices 110-B according to a second radio access technology is provided. The network node 160 includes a first processing block within processing circuitry QQ170 operating according to the first radio access technology and configured to: determine a delay and phase error based at least in part on feedback from at least one of the first wireless devices; and compensate a first transmitted signal based at least in part on the determined delay and phase error. The network node 160 further includes a second processing block within processing circuitry QQ170 operating according to the second radio access technology and configured to compensate a second transmitted signal based at least in part on the determined delay and phase error received from the first processing block.

According to this aspect, in some embodiments, the compensated first transmitted signal is transmitted to at least one of the first wireless devices 110-A. In some embodiments, the compensated second transmitted signal is transmitted to at least one of the second wireless devices 110-B. In some embodiments, the first radio access technology is New Radio, NR, and the second radio access technology is Long Term Evolution, LTE. In some embodiments, the determined delay and phase error are monitored over time and reported periodically to the second processing block. In some embodiments, both the first and second processing blocks being in communication with a same remote radio unit at the network node 160.

According to another aspect, a method in a network node 160 configured to communicate with first wireless devices 110-A according to a first radio access technology and to communicate with second wireless devices 110-B according to a second radio access technology is provided. The method includes determining, via the processing circuitry QQ170, for example, a delay and phase error at a first processing block based at least in part on feedback from at least one of the first wireless devices 110-A. The method also includes compensating, via the processing circuitry QQ170, for example, a first transmitted signal based at least in part on the determined delay and phase error. The method further includes compensating, via the processing circuitry QQ170, for example, at a second processing block a second transmitted signal based at least in part on the determined delay and phase error received from the first processing block.

According to this aspect, in some embodiments, the compensated first transmitted signal is transmitted to at least one of the first wireless devices 110-A. In some embodiments, the compensated second transmitted signal is transmitted to at least one of the second wireless devices 110-B. In some embodiments, the first radio access technology is New Radio, NR, and the second radio access technology is Long Term Evolution, LTE. In some embodiments, the determined delay and phase error are monitored over time and reported periodically to the second processing block. In some embodiments, both the first and second processing blocks being in communication with a same remote radio unit at the network node 160.

According to yet another aspect, a network node 160 configured to communicate with New Radio, NR, wireless devices 110-A and to communicate with Long Term Evolution, LTE, wireless devices 110-B is provided. The network node 160 includes an NR processing block configured to: determine a delay and phase error based at least in part on feedback from at least one of the NR wireless devices 110-A; and compensate transmitted first signals based at least in part on the determined delay and phase error. The network node further includes an LTE processing block being configured to compensate transmitted second signals based at least in part on the determined delay and phase error received from the NR processing block.

According to this aspect, in some embodiments, the compensated transmitted first signals are transmitted to at least one of the NR wireless devices 110-A. In some embodiments, the compensated transmitted second signals are transmitted to at least one of the LTE wireless devices 110-B. In some embodiments, the determined delay and phase error are monitored over time and transmitted to the LTE processing block periodically. In some embodiments, the network node 160 is a combination of an NR base station, gNB, and an LTE base station, eNB. In some embodiments, the network node 160 further includes a remote radio unit to transmit first signals to the NR wireless devices 110-A and to transmit second signals to the LTE wireless devices 110-B. In some embodiments, the delay and phase error are determined at a frequency that is used for transmission by the remote radio unit of both the first signals and the second signals.

According to yet another aspect, a method in a network node 160 is configured to communicate with New Radio, NR, wireless devices 110-A and to communicate with Long Term Evolution, LTE, wireless devices 110-B. The method includes determining a delay and phase error based at least in part on feedback from at least one of the NR wireless devices 110-A. The method also includes compensating transmitted first signals based at least in part on the determined delay and phase error, and compensating transmitted second signals based at least in part on the determined delay and phase error.

According to this aspect, in some embodiments, the compensated transmitted first signals are transmitted to at least one of the NR wireless devices 110-A. In some embodiments, the compensated transmitted second signals are transmitted to at least one of the LTE wireless devices 110-B. In some embodiments, the determined delay and phase error are monitored over time and transmitted to the LTE processing block periodically. In some embodiments, the network node 160 is a combination of an NR base station, gNB 160-A, and an LTE base station, eNB 160-B. In some embodiments, the method also includes transmitting first signals to the NR wireless devices 110-A and to transmit second signals to the LTE wireless devices 110-B. In some embodiments, the delay and phase error are determined at a frequency that is used for transmission of both the first signals and the second signals.

Some embodiments may include the following:

### GROUP A EMBODIMENTS

A1. A method to calibrate an antenna is a wireless network where a NR network node (gNB) and an LTE network node (eNB) share a radio unit, the method comprising:
   using a NR user equipment device (NR WD) on the gNB for radio delay and phase error estimation;
   providing the radio delay and phase error estimation to the eNB to assist the eNB in performing delay and phase compensation.
A2. The method of embodiment 1, wherein the step of using a NR user equipment further comprising the step of configuring by the gNB a plurality of RS(s) for WD to perform channel and/or interference measurement.
A3. The method of embodiment 2, wherein the RS could be one or more of CSI-RS, DMRS, TRS, PTRS, PSS, SSS, or any other reference signal.
A4. The method of embodiment 1, wherein the step of using a NR user equipment further comprising the step of NR WD provides CSI feedback to the gNB.
A5. The method of embodiment 4, wherein the step of using a NR user equipment further comprising the step of estimating by the gNB, after the gNB obtains the CSI feedback, the radio phase and delay error.
A6. The method of any of the embodiments 1-5, wherein the step of using a NR user equipment further comprising the step of sending by the gNB the estimated radio phase and delay error to eNB.
A7. The method of any of the embodiments 1-5, further comprising the step of using by the gNB the estimated radio phase and delay error to compensate gNB transmitted signal and transmits the corresponding compensated signal to NR WDs.
A8. The method of any of the embodiments 1-5, further comprising the step of tracking by the gNB the delay and phase error over time in order to tracking the delay and phase shift over time.

### GROUP C EMBODIMENTS

C1. A wireless device for to calibrate an antenna is a wireless network where a NR network node (gNB) and an LTE network node (eNB) share a radio unit, the wireless device comprising:
   processing circuitry configured to perform any of the steps of any of the Group A embodiments; and
   power supply circuitry configured to supply power to the wireless device.
C2. A base station for to calibrate an antenna is a wireless network where a NR network node (gNB) and an LTE network node (eNB) share a radio unit, the base station comprising:
   processing circuitry configured to perform any of the steps of any of the Group B embodiments;
   power supply circuitry configured to supply power to the base station.
C3. A user equipment (UE) for to calibrate an antenna is a wireless network where a NR network node (gNB) and an LTE network node (eNB) share a radio unit, the WD comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the WD to be processed by the processing circuitry;
   an output interface connected to the processing circuitry and configured to output information from the WD that has been processed by the processing circuitry; and
   a battery connected to the processing circuitry and configured to supply power to the WD.
C4. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
C5. The communication system of the previous embodiment further including the base station.
C6. The communication system of the previous 2 embodiments, further including the WD, wherein the WD is configured to communicate with the base station.
C7. The communication system of the previous 3 embodiments, wherein:
   the processing circuitry of the host computer is configured to execute a host application, thereby providing the user data; and
   the WD comprises processing circuitry configured to execute a client application associated with the host application.
C8. A method implemented in a communication system including a host computer, a base station and a user equipment (UE), the method comprising:
   at the host computer, providing user data; and
   at the host computer, initiating a transmission carrying the user data to the WD via a cellular network comprising the base station, wherein the base station performs any of the steps of any of the Group B embodiments.
C9. The method of the previous embodiment, further comprising, at the base station, transmitting the user data.
C10. The method of the previous 2 embodiments, wherein the user data is provided at the host computer by executing a host application, the method further comprising, at the WD, executing a client application associated with the host application.
C11. A user equipment (UE) configured to communicate with a base station, the WD comprising a radio interface and processing circuitry configured to performs the of the previous 3 embodiments.
C12. A communication system including a host computer comprising:
   processing circuitry configured to provide user data; and
   a communication interface configured to forward user data to a cellular network for transmission to a user equipment (UE),
   wherein the WD comprises a radio interface and processing circuitry, the WD's components configured to perform any of the steps of any of the Group A embodiments.
C13. The communication system of the previous embodiment, wherein the cellular network further includes a base station configured to communicate with the WD.
C14. The communication system of the previous 2 embodiments, wherein:
   the processing circuitry of the host computer is configured to execute a host application, thereby providing the user data; and
   the WD's processing circuitry is configured to execute a client application associated with the host application.
C15. A method implemented in a communication system including a host computer, a base station and a user equipment (UE), the method comprising:
   at the host computer, providing user data; and
   at the host computer, initiating a transmission carrying the user data to the WD via a cellular network comprising the base station, wherein the WD performs any of the steps of any of the Group A embodiments.
C16. The method of the previous embodiment, further comprising at the WD, receiving the user data from the base station.
C17. A communication system including a host computer comprising:
   communication interface configured to receive user data originating from a transmission from a user equipment (UE) to a base station,
   wherein the WD comprises a radio interface and processing circuitry, the WD's processing circuitry configured to perform any of the steps of any of the Group A embodiments.
C18. The communication system of the previous embodiment, further including the WD.
C19. The communication system of the previous 2 embodiments, further including the base station, wherein the base station comprises a radio interface configured to communicate with the WD and a communication interface configured to forward to the host computer the user data carried by a transmission from the WD to the base station.
C20. The communication system of the previous 3 embodiments, wherein:
   the processing circuitry of the host computer is configured to execute a host application; and
   the WD's processing circuitry is configured to execute a client application associated with the host application, thereby providing the user data.
C21. The communication system of the previous 4 embodiments, wherein:
   the processing circuitry of the host computer is configured to execute a host application, thereby providing request data; and
   the WD's processing circuitry is configured to execute a client application associated with the host application, thereby providing the user data in response to the request data.
C22. A method implemented in a communication system including a host computer, a base station and a user equipment (UE), the method comprising:
   at the host computer, receiving user data transmitted to the base station from the WD, wherein the WD performs any of the steps of any of the Group A embodiments.
C23. The method of the previous embodiment, further comprising, at the WD, providing the user data to the base station.
C24. The method of the previous 2 embodiments, further comprising:
   at the WD, executing a client application, thereby providing the user data to be transmitted; and
   at the host computer, executing a host application associated with the client application.
C25. The method of the previous 3 embodiments, further comprising:
   at the WD, executing a client application; and
   at the WD, receiving input data to the client application, the input data being provided at the host computer by executing a host application associated with the client application,
   wherein the user data to be transmitted is provided by the client application in response to the input data.
C26. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
C27. The communication system of the previous embodiment further including the base station.
C28. The communication system of the previous 2 embodiments, further including the WD, wherein the WD is configured to communicate with the base station.
C29. The communication system of the previous 3 embodiments, wherein:
   the processing circuitry of the host computer is configured to execute a host application;
   the WD is configured to execute a client application associated with the host application, thereby providing the user data to be received by the host computer.
C30. A method implemented in a communication system including a host computer, a base station and a user equipment (UE), the method comprising:
   at the host computer, receiving, from the base station, user data originating from a transmission which the base station has received from the WD, wherein the WD performs any of the steps of any of the Group A embodiments.
C31. The method of the previous embodiment, further comprising at the base station, receiving the user data from the WD.
C32. The method of the previous 2 embodiments, further comprising at the base station, initiating a transmission of the received user data to the host computer.

### Abbreviations

At least some of the following abbreviations may be used in this disclosure. If there is an inconsistency between abbreviations, preference should be given to how it is used above. If listed multiple times below, the first listing should be preferred over any subsequent listing(s).
AAS Active Antenna System
1×RTT CDMA2000 1× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH
   Received energy per chip divided by the power density in the band
CQI Channel Quality information
C-RNTI Cell RNTI
CSI Channel State Information
CSI-RS Channel State Information Reference Signal
DCCH Dedicated Control Channel
DFT Discrete Fourier Transform
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
MU-MIMO Multi-User MIMO
NPDCCH Narrowb and Physical Downlink Control Channel
NR New Radio
NZP-CSI-RS Non-zero power CSI-RS
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RI Rank Indication
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
   Reference Signal Received Power
RSRQ Reference Signal Received Quality OR
   Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SRS Sounding Reference Signal
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

Any appropriate steps, methods, features, functions, or benefits disclosed herein may be performed through one or more functional units or modules of one or more virtual apparatuses. Each virtual apparatus may include a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to transmit signals to first wireless devices according to a first radio access technology and to transmit signals to second wireless devices according to a second radio access technology, the network node comprising:
a first processing block operating according to the first radio access technology and configured to:
determine a delay and phase error based at least in part on feedback from at least one of the first wireless devices;
compensate a first transmitted signal based at least in part on the determined delay and phase error; and
a second processing block operating according to the second radio access technology and configured to compensate a second transmitted signal based at least in part on the determined delay and phase error received from the first processing block.

2. The network node of claim 1, wherein the compensated first transmitted signal is transmitted to at least one of the first wireless devices.

3. The network node of claim 1, wherein the compensated second transmitted signal is transmitted to at least one of the second wireless devices.

4. The network node of claim 1, wherein the first radio access technology is New Radio, NR, and the second radio access technology is Long Term Evolution, LTE.

5. The network node of claim 1, wherein the determined delay and phase error are monitored over time and reported periodically to the second processing block.

6. The network node of claim 1, wherein both the first and second processing blocks are in communication with a same remote radio unit at the network node.

7. A method in a network node configured to communicate with first wireless devices according to a first radio access technology and to communicate with second wireless devices according to a second radio access technology, the method comprising:
determining a delay and phase error at a first processing block based at least in part on feedback from at least one of the first wireless devices;
compensating a first transmitted signal based at least in part on the determined delay and phase error; and
compensating at a second processing block a second transmitted signal based at least in part on the determined delay and phase error received from the first processing block.

8. The method of claim 7, wherein the compensated first transmitted signal is transmitted to at least one of the first wireless devices.

9. The method of claim 7, wherein the compensated second transmitted signal is transmitted to at least one of the second wireless devices.

10. The method of claim 7, wherein the first radio access technology is New Radio, NR, and the second radio access technology is Long Term Evolution, LTE.

11. The method of claim 7, wherein the determined delay and phase error are monitored over time and reported periodically to the second processing block.

12. The method of claim 7, wherein both the first and second processing blocks are in communication with a same remote radio unit at the network node.

13. A network node configured to communicate with New Radio, NR, wireless devices and to communicate with Long Term Evolution, LTE, wireless devices, the network node comprising:
an NR processing block configured to:
determine a delay and phase error based at least in part on feedback from at least one of the NR wireless devices;
compensate transmitted first signals based at least in part on the determined delay and phase error; and
an LTE processing block being configured to compensate transmitted second signals based at least in part on the determined delay and phase error received from the NR processing block.

14. The network node of claim 13, wherein the compensated transmitted first signals are transmitted to at least one of the NR wireless devices.

15. The network node of claim 13, wherein the compensated transmitted second signals are transmitted to at least one of the LTE wireless devices.

16. The network node of claim 13, wherein the determined delay and phase error are monitored over time and transmitted to the LTE processing block periodically.

17. The network node of claim 13, wherein the network node is a combination of an NR base station, gNB, and an LTE base station, eNB.

18. The network node of claim 13, further comprising a remote radio unit to transmit first signals to the NR wireless devices and to transmit second signals to the LTE wireless devices.

19. The network node of claim 13, wherein the delay and phase error are determined at a frequency that is used for transmission by the remote radio unit of both the first signals and the second signals.

20. A method in a network node configured to communicate with New Radio, NR, wireless devices and to communicate with Long Term Evolution, LTE, wireless devices, the method comprising:
determining a delay and phase error based at least in part on feedback from at least one of the NR wireless devices;
compensating transmitted first signals based at least in part on the determined delay and phase error; and
compensating transmitted second signals based at least in part on the determined delay and phase error.

21. The method of claim 20, wherein the compensated transmitted first signals are transmitted to at least one of the NR wireless devices.

22. The method of claim 20, wherein the compensated transmitted second signals are transmitted to at least one of the LTE wireless devices.

23. The method of claim 20, wherein the determined delay and phase error are monitored over time and transmitted to the LTE processing block periodically.

24. The method of claim 20, wherein the network node is a combination of an NR base station, gNB, and an LTE base station, eNB.

25. The method of claim 20, further comprising transmitting first signals to the NR wireless devices and to transmit second signals to the LTE wireless devices.

26. The method of claim 20, wherein the delay and phase error are determined at a frequency that is used for transmission of both the first signals and the second signals.
